(19) United States
(12) Patent Application Publication
(10) Pub. No.: US 2005/0270509 A1
(43) Pub. Date: Dec. 8, 2005

(54) Measuring apparatus, exposure apparatus having the same, and device manufacturing method

(76) Inventors: Nobuaki Ogushi, Utsunomiya-shi (JP); Mitsuaki Amemiya, Saitama-shi (JP)

Correspondence Address: MORGAN & FINNEGAN, L.L.P., 3 WORLD FINANCIAL CENTER, NEW YORK, NY, 10281-2101, US

(21) Appl. No.: 11/144,319

(22) Filed: Jun. 3, 2005

(30) Foreign Application Priority Data
Jun. 3, 2004 (JP) 2004-165878

(51) Int. Cl. G03B 27/52

(52) U.S. Cl. 355/55; 355/53

(57) ABSTRACT

A measuring apparatus according for measuring relative positions between a first mark on a movable reticle stage to hold a reticle, and a second mark on a movable object stage to hold an object to be exposed, the apparatus includes a detector for detecting light that has passed the first and second marks, and a processor for calculating the relative positions based on an output of the detector, wherein each of the first and second marks includes plural patterns to direct the light, at least ones of widths and intervals of the plural patterns being non-uniform.

### BACKGROUND OF THE INVENTION

The present invention relates to an exposure apparatus, and more particularly to a measuring apparatus for aligning a reticle and an object to be exposed relative to each other, an exposure apparatus having the same, and a device manufacturing method for using the exposure apparatus.

Along with the recent demands for smaller and less expensive electronic apparatuses, an exposure apparatus that manufactures large-scale integrated circuits (“LSIs”) mounted in these exposure apparatuses is required to provide highly accurate exposure at the improved productivity. Thus, the exposure apparatus aligns a reticle with a wafer using a driver and an alignment means (such as a reticle reference mark formed on a reticle stage, a wafer reference mark formed on a wafer stage, and a photoelectric detector). The reticle and wafer reference marks generally include a rectangular single slit pattern. These patterns are similar but the wafer pattern is, for example, about ¼ or ⅕ as large as the reticle pattern.

In alignment, the photoelectric detector detects the light that has transmitted through or is reflected on the reticle and wafer reference marks, and a driver aligns the reticle reference mark with the wafer reference mark based on the light intensity that has transmitted the masks. The driver moves the reticle and the wafer so as to maximize the light intensity. See Japanese Patent Publication No. 02-58766 (Patent Reference No. 1). As more precise exposure is required, the slit should be narrower for the improved alignment precision. However, the narrower slit makes the light intensity and the S/N ratio too low to provide accurate detections. One solution for this problem is to use plural, similarly shaped and regularly arranged slits for the alignment mark in order to increase the light intensity. See Japanese Patent Publication No. 04-30735 (Patent Reference No. 2).

However, the alignment mark of Patent Reference No. 2 has plural peaks, requiring a long time for a detection of the maximum peak and causing a misdetection of the maximum peak. As a result, the throughput sometimes lowers, and the resolution and the overlay deteriorate.

### BRIEF SUMMARY OF THE INVENTION

Accordingly, it is an exemplary object of the present invention to provide a novel measurement technique directed to an alignment of a reticle and an object to be exposed relative to each other.

A measuring apparatus according to one aspect of the present invention for measuring relative positions between a first mark on a movable reticle stage to hold a reticle, and a second mark on a movable object stage to hold an object to be exposed, the apparatus includes a detector for detecting light that has passed the first and second marks, and a processor for calculating the relative positions based on an output of the detector, wherein each of the first and second marks includes plural patterns to direct the light, at least ones of widths and intervals of the plural patterns being non-uniform.

An exposure apparatus according to another aspect of the present invention for exposing an object to a pattern of a reticle, the apparatus includes a movable reticle stage to hold the reticle, a movable object stage to hold the object, the above measuring apparatus, and a controller to control positions of the movable reticle stage and the movable object stage based on a relative position measured by the measuring apparatus.

A method of manufacturing a device according to another aspect of the present invention includes steps of exposing an object to a pattern of a reticle using the above exposure apparatus, developing the exposed object, and processing the developed object to manufacture the device.

### BRIEF DESCRIPTION OF THE DRAWINGS

FIG. 1 is a schematic structure of an exposure apparatus that includes an inventive alignment means.

FIGS. 2A and 2B are schematic plane view of a reticle reference mark and a wafer reference mark shown in FIG. 1.

FIGS. 3A and 3B are a table and a graph for explaining a pseudorandom noise (“PN”) code having a code length of 7 for the reticle and wafer reference marks shown in FIG. 2.

FIGS. 4A and 4B are graphs of the light intensity that transmits the wafer reference mark and is detected by a photoelectric detector in the inventive alignment means shown in FIG. 1.

FIG. 5 is a schematic perspective view of a second embodiment of the wafer reference mark shown in FIG. 2.

FIGS. 6A and 6B are schematic perspective views of a third embodiment of the wafer reference mark shown in FIG. 2.

FIGS. 7A and 7B are graphs of a signal relating to the wafer reference mark of the third embodiment from the photoelectric detector shown in FIGS. 6A and 6B.

FIG. 8 is a schematic perspective view of a fourth embodiment of a wafer reference mark shown in FIG. 2.

FIG. 9 is a flowchart of an alignment method using the alignment means shown in FIG. 9.

FIG. 10 is a flowchart for explaining the way of manufacturing devices (such as semiconductor chips such as ICs and LCDs and CCDs) using the exposure apparatus shown in FIG. 1.

FIG. 11 is a detailed flowchart of Step 4 in FIG. 10.

### DETAILED DESCRIPTION OF THE PREFERRED EMBODIMENTS

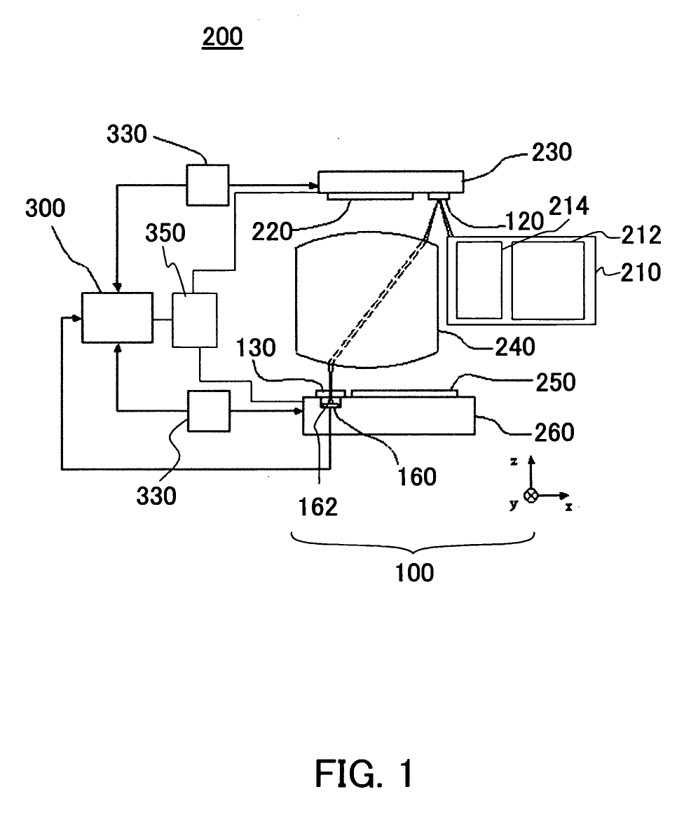

With reference to the accompanying drawings, a description will now be given of an alignment means 100 and an exposure apparatus 200 having the same according one aspect of the present invention. Here, FIG. 1 shows a structure of the exposure apparatus 200. The alignment means 100 serves to detect a position for an alignment, and includes a reticle reference mark 120, a wafer reference mark 130 and a photoelectric detector 160. The alignment means 100 is arranged in the exposure apparatus 200, and executes an alignment in cooperation with a driver 330, which is described later.

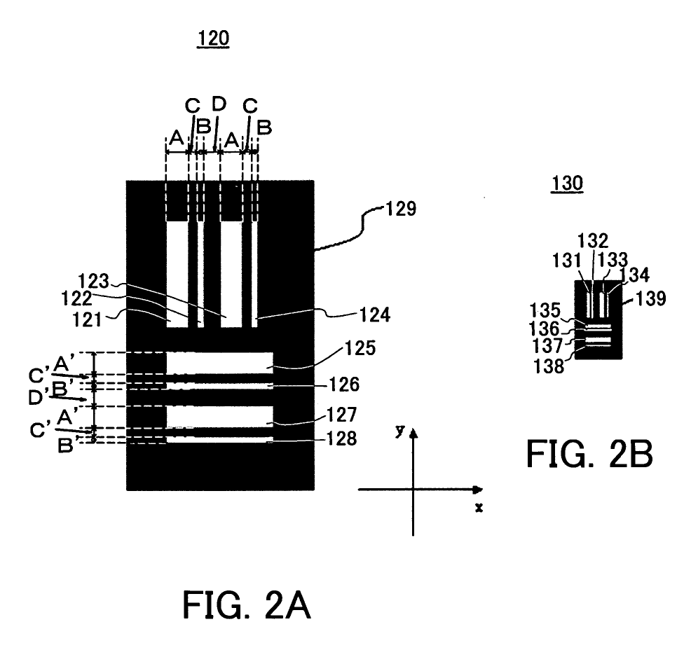

The reticle reference mark 120 serves to reflect and absorb the light. The reticle reference mark 120 is arranged on a reticle stage 230, which will be described later, and includes, as shown in FIG. 2A, patterns 121 to 128 that reflect the detection light for an alignment, change the light intensity in accordance with an offset amount, and have different widths and intervals. Three or more patterns are preferable. Here, FIG. 2A is a plan view of the reticle reference mark 120.

The patterns 121 to 124 are orthogonal to the patterns 125 to 128. A width A of the patterns 121 and 123 is different from a width B of the patterns 122 and 124; a width A′ of the patterns 125 and 127 is different from a width B′ of the patterns 126 and 128. An interval D between the patterns 122 and 123 is different from an interval C between the patterns 121 and 122 and between the patterns 123 and 124. An interval D′ between the patterns 126 and 127 is different from an interval C′ between the patterns 125 and 126 and between the patterns 127 and 128. The adjacent marks thus have different widths and intervals. The width A of the patterns 121 and 123 is greater than the width B of the patterns 122 and 124, and the width A′ of the patterns 125 and 127 is greater than the width B′ of the patterns 126 and 128.

Although the alignment mark in Patent Reference No. 1 has a single slit pattern suitable for an easy detection of a peak position, the pattern should be narrower in order to improve the detecting precision. Even when Patent Reference No. 1 attempts to provide accurate alignments with the narrower pattern, the reduced light intensity lowers the maximum peak value and makes the peak detection difficult. An alignment mark in Patent Reference No. 2 has plural patterns so as to increase the light intensity, but the detected plural peak positions make difficult to find the maximum peak position.

On the other hand, the reticle reference mark 120 of this embodiment has the narrow patterns 122, 124, 126 and 128 so as to improve the precision of the peak detection, and wide patterns 121, 123, 125 and 127 so as to increase the light intensity. Due to these patterns 121 to 128, the exposure apparatus 200 is less likely to provide an alignment based on an erroneous peak. The exposure apparatus 200 maintains the resolution due to the accurate alignment. A sudden peak of the light intensity accelerates the peak detections without thorough scanning of the mark. This precise and easy alignment improves the throughput and productivity. The patterns 121 to 124 are used for an alignment between the reticle 220 and object 250 in an X direction, and the patterns 125 to 128 are used for an alignment between them in a Y direction.

The reticle reference mark 120 reflects the exposure light on the patterns 121 to 128, and absorbs the exposure light on a mark frame 129. The patterns 121-128 may be slits that transmit the exposure light in accordance with a structure of the exposure apparatus 200. The reticle reference mark 120 is not limited to this embodiment with respect to the number of patterns, the interval and the width. The above effect is available by using either a mark width or a mark interval, for example, while this embodiment uses a pseudorandom noise (“PN”) code pattern.

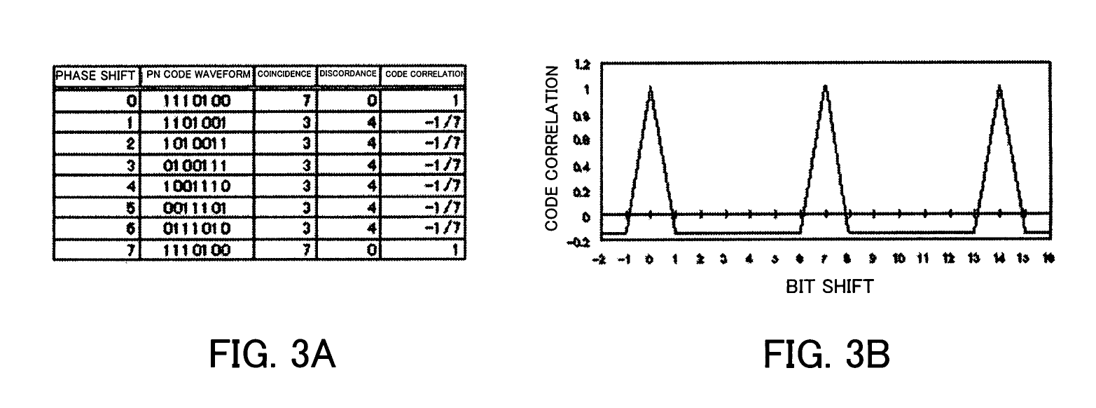

The PN means a bit string that imitates a random noise. The PN code periodically repeats the random bit string. For example, the PN code periodically repeats “1110100”. The PN code is characterized as shown in FIGS. 3A and 3B in that a code phase peaks when the PN code shifts by a code length of 7 of “1110100” and all codes overlap each other or when a phase shift is 0 and 7. When a light projection by the reticle reference mark 120 is defined as “1” (at patterns 121 to 124 or patterns 125 to 128) and the light shielding by it is defined as “0”, the light intensity enhances when all the patterns 121 to 124 or all the patterns 125 to 128 overlap the wafer reference marks 131 to 134 or the marks 135 to 138, which will be described later. This configuration facilitates the peak determination, and the alignment means 100 is less likely to provide an alignment based on an erroneous peak. The exposure apparatus 200 that has the alignment means 100 realizes the precise alignment and fine processing. A sudden peak of the light intensity accelerates peak detections without thorough scanning of the mark. This precise and easy alignment improves the throughput and productivity. Here, FIGS. 3A and 3B are a table and a graph for explaining a PN code having a code length of 7. More specifically, FIG. 3A is a table that correlates a phase shift with a code correlation, and FIG. 3B is a graph that shows a relationship between a code correlation and a bit shift.

The wafer reference mark 130 serves to transmit and absorb the light. The wafer reference mark 130 is arranged on a wafer stage 260, which will be described later, and includes, as shown in FIG. 2B, patterns that transmit and reflect the detection light for alignment, have different widths or intervals, and change the light intensity in accordance with the shift amount. Here, FIG. 2B is a plane view of the wafer reference mark 130. Although the wafer reference mark 130 is similar to the reticle reference mark 120, the patterns 131 to 138 transmit, not reflect, the light. The wafer reference mark 130 is about ¼ or ⅕ as large as the reticle reference marks 120. Other than that, the wafer reference mark 130 is the same as the reticle reference mark 120, and a description will be omitted. Of course, the wafer reference mark 130 may reflect the light.

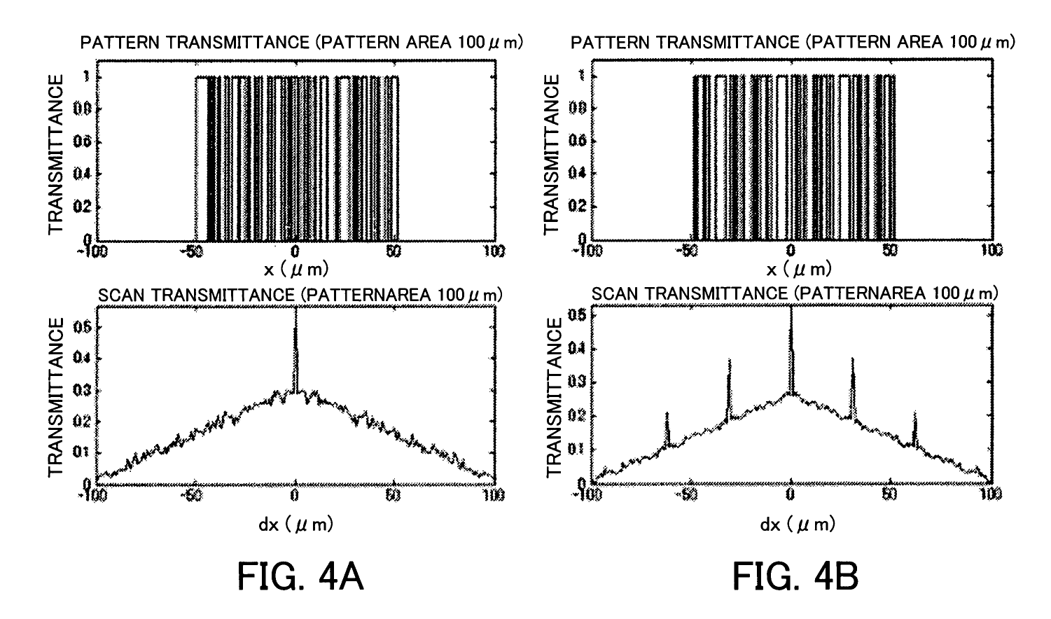

The photoelectric detector 160 serves to detect the incident light intensity. The photoelectric detector 160 detects the light intensity that transmits the wafer reference mark 130, and arranges a light intensity detector 162 below the wafer reference mark 130. The light intensity detector 162 is so dimensioned that it can detect a mark in one direction or measure the patterns 121 to 124 or the patterns 125 to 128. Thus, the photoelectric detector 160 detects positions of the reticle 220 and object 250 separately in the X and Y directions. FIGS. 4A and 4B show light intensity measurement results by the photoelectric detector 160. FIG. 4A and 4B are graphs of the light intensities that transmit the wafer reference mark 130 and are detected by the photoelectric detector 160. FIG. 4A is the graph generated from a PN code pattern having a code length of 127. In FIG. 4A, a pattern of 100 bits is drawn with a minimum critical dimension (“CD”) of 1 μm in an area of 100 μm. Since only one peak is detected during scanning, a misdetection of the peak will not happen. The exposure apparatus 200 that has the alignment means 100 realizes the precise alignment and improves the resolution. A sudden peak of the light intensity accelerates a detection of the maximum peak without thorough scanning of the mark. This precise and easy alignment improves the throughput and productivity. Even if the peak position shifts slightly, there is a sufficient light intensity and movements of the wafer stage 260 in a direction that increases the light intensity facilitate the peak search. The curve fitting and detecting of the center of gravity makes the resolution of the peak detection smaller than the minimum CD of the pattern.

FIG. 4B shows five peaks arranged at regular intervals as a result of scanning of a PN code pattern having a code length of 31 is drawn by three cycles +a. While the plural peaks sacrifice the searching easiness to some extent, the accuracy improves with the detections of the plural peaks by averaging and peak interval calculations. As a result, the exposure apparatus 200 that has the alignment means 100 realizes the precise alignment and fine processing. Since the code length determines the number of peaks and the code length is defined as 2ⁿ⁻¹ (n: integer), the code string is properly selected in the design. The photoelectric detector 160 can use another type.

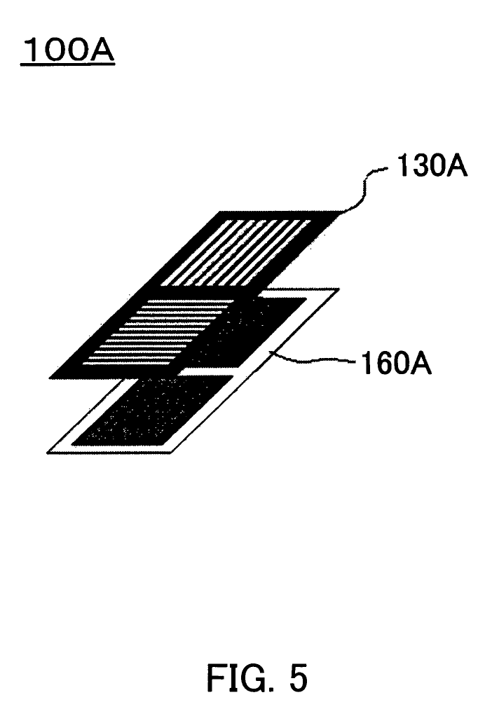

With reference to FIG. 5, a description will now be given of an alignment means 100A. FIG. 5 is a perspective view of a wafer reference mark 130A as a second embodiment of the wafer reference mark 130. FIG. 5 shows a two-section photoelectric detector 160A having light receiving surfaces corresponding to patterns use to detect the X and Y directions in the wafer reference mark 130A. The two-element photoelectric detector 160A detects peaks in the X and Y directions simultaneously, providing a prompt measurement and alignment, unlike the one-element photoelectric detector that repeats the measurement for each direction. This precise and easy alignment improves the throughput and productivity. The reticle reference mark 120 can also be changed like the wafer reference mark 130A.

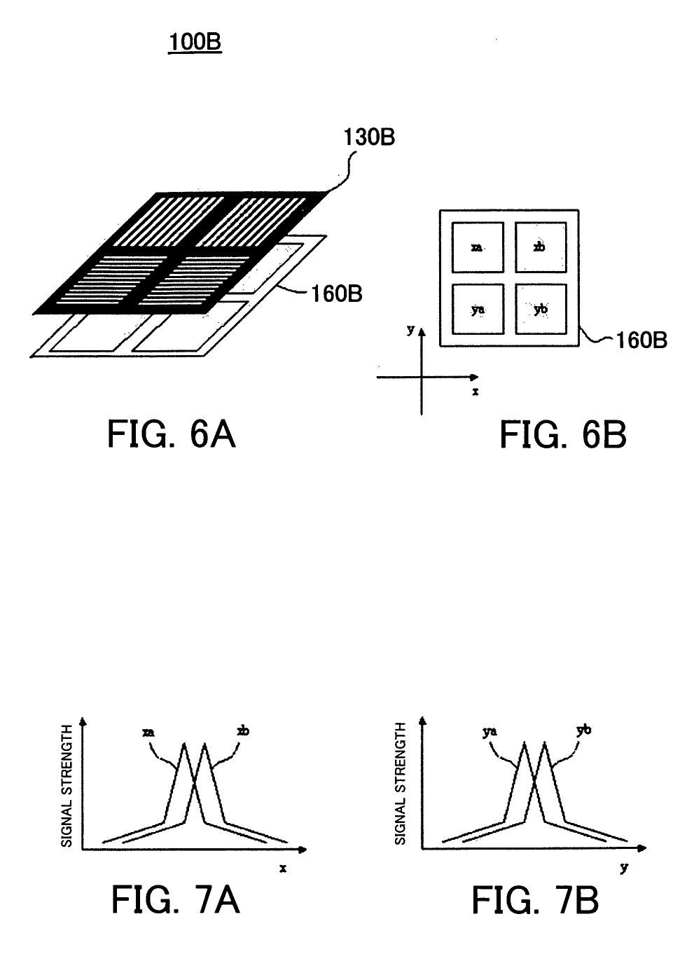

With reference to FIGS. 6A and 6B, a description will now be given of an alignment means 100B. FIG. 6A is a perspective view of a wafer reference mark 130B as a third embodiment of the wafer reference mark 130. FIG. 6B shows the wafer reference mark 130B having a pair of two-element patterns used to detect the X and Y directions and a four-section photoelectric detector 160B. The wafer reference mark 130B's patterns corresponding to xa and xb shift from the reticle reference mark 120 by half a pitch of the minimum CD. This configuration obtains a matching position between the signal strengths from the xa and xb patterns, and accelerates the alignment by saving scanning in the X direction, as shown in FIG. 7A. This applies similarly to the Y direction as shown in FIG. 7B. This configuration facilitates the peak determination, and the alignment means 100B is less likely to provide an alignment based on an erroneous peak. The exposure apparatus 200 that includes the alignment means 100B can maintain the resolution due to the highly accurate alignment. A sudden peak of the light intensity provides a quick positional detection without scanning of all the peaks. This precise and easy alignment improves the throughput and productivity. Here, FIGS. 7A and 7B are graphs of signals from the photoelectric detector and the wafer reference mark 130B of the third embodiment. The reticle reference mark 120 can also be changed like the wafer reference mark 130B.

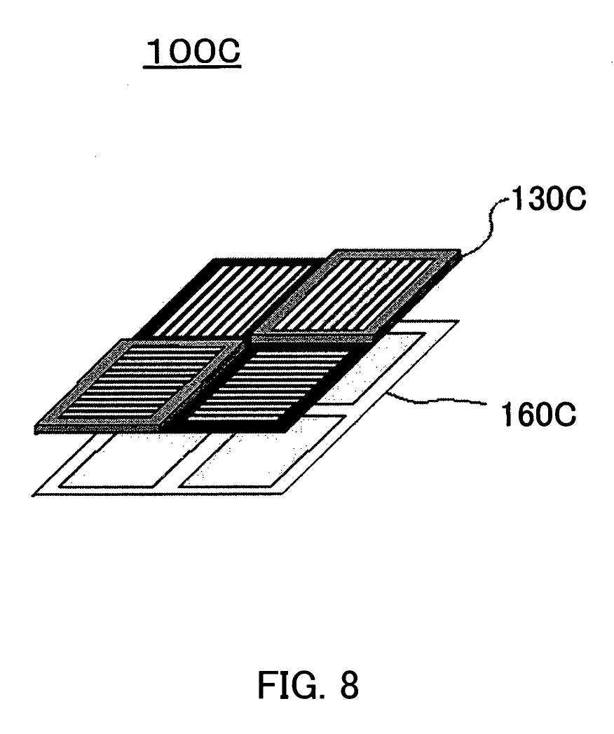

With reference to FIG. 8, a description will now be given of an alignment means 100C. FIG. 8 is a perspective view of a wafer reference mark 130C as a fourth embodiment of the wafer reference mark 130.

Similar to the third embodiment, FIG. 8 shows a four-section photoelectric detector 160C having light receiving surface corresponding to a pair of two-element patterns used to detect the X and Y directions. This embodiment differs from the third embodiment in that two patterns that are sensitive to the X and Y directions are stepped. Thereby, this configuration obtains a matching position between two elements' signals without scanning in the z (or focus) direction, and provides rapider alignment than the third embodiment. This configuration facilitates the peak determination, and the alignment means 100C is less likely to provide an alignment based on an erroneous peak. The exposure apparatus 200 that includes the alignment means 100C can maintain the resolution due to the highly accurate alignment. A sudden peak of the light intensity provides a quick positional detection without scanning of all the peaks. This precise and easy alignment improves the throughput and productivity. The step needs to smaller than the depth of focus (“DOF”) determined by the exposure light's wavelength λ and the projection optical system 240's NA (DOF=kλ(NA)² k: constant). While this embodiment measures positions in the X, Y and Z positions by providing a step to one of the marks in the X and Y directions, only the X and Z or Y and Z directions may be measured. The reticle reference mark 120 can also be changed like the wafer reference mark 130C.

Referring now to FIG. 1, a description will be given of the exemplary exposure apparatus 200. The exposure apparatus 200 includes, as shown in FIG. 1, an illumination apparatus 210 that illuminates a reticle (or a mask) 220 which has a circuit pattern, a reticle stage 230 that supports the reticle 220, a projection optical system 240 that projects the illuminated reticle pattern onto a object 250, and a wafer stage 260 that supports the object 250.

The exposure apparatus 200 is a projection exposure apparatus that exposes onto the object 250 a circuit pattern on the reticle 220 in a step-and-scan manner. Of course, the present invention is applicable to a step-and-repeat exposure apparatus (“stepper”). Such an exposure apparatus is suitable for a sub-micron or quarter-micron lithography process. The instant embodiment exemplarily describes a step-and-scan exposure apparatus (which is also called “scanner”). “The step-and-scan manner”, as is used herein, is an exposure method that exposes a mask pattern onto a wafer by continuously scanning the wafer relative to the mask, and by moving the wafer stepwise to the next exposure area to be shot after one shot of exposure. “The step-and-repeat manner” is another exposure method that moves a wafer stepwise to an exposure area for the next shot every short of cell projection.

The illumination apparatus 210 illuminates the reticle 220 that has a circuit pattern to be transferred, and includes a light source unit 212 and an illumination optical system 214.

The light source unit 212 uses a laser as a light source. The laser may use, for example, an ArF excimer laser with a wavelength of approximately 193 nm, an KrF excimer laser with a wavelength of approximately 248 nm, and an F₂ laser with a wavelength of approximately 157 nm, etc. The type of laser is not limited to the excimer laser, and a YAG laser may be used, for example. The number of laser units is not limited. For example, two independently acting solid lasers would cause no coherence between these solid lasers and significantly reduce speckles resulting from the coherence. An optical system may swing linearly or rotationally so as to reduce the speckles. When the light source unit 212 uses laser, it is desirable to employ the light shaping optical system that shapes a parallel beam from a laser source into a desired beam shape, and an incoherently turning optical system that turns a coherent laser beam into an incoherent one. A light source applicable to the light source unit 212 is not limited to a laser. One or more lamps, such as a mercury lamp and a xenon lamp, may be used.

The illumination optical system 214 is an optical system that illuminates the reticle 220, and includes a lens, a mirror, a light integrator, a stop, and the like. For example, a condenser lens, a fly-eye lens, an aperture stop, a condenser lens, a slit, and an imaging optical system are arranged in this order. The illumination optical system 214 can use any light regardless of whether it is the on-axial or off-axial light. The light integrator may include a fly-eye lens or an integrator formed by stacking two sets of cylindrical lens array plates (or lenticular lenses), and be replaced with an optical rod or a diffractive element.

The reticle 220 is made for example, of quartz, and has a circuit pattern (or an image) to be transferred. It is supported and driven by a reticle stage (not shown). The diffracted light emitted from the reticle 220 passes the projection optical system 240, and then projected onto the object 250. The object 250 is a semiconductor wafer or a liquid crystal substrate, and the photoresist is applied on the object 250. The reticle 220 and the object 250 are located in an optically conjugate relationship. Since the exposure apparatus 200 of the instant embodiment is a scanner, the reticle 220 and the object 250 are scanned at a speed of the reduction ratio. Thus, the pattern on the reticle 220 is transferred to the object 250. If the exposure apparatus 200 is a stepper, the reticle 220 and the object 250 remain stationary during exposure.

The reticle stage 230 supports the reticle 220 via a reticle chuck (not shown), and is connected to a moving mechanism (not shown). The moving mechanism (not shown) includes a linear motor, and moves the reticle stage 230 and the reticle 220 in and around the XYZ directions. Here, the Y-axis is a scan direction on the reticle 220 or object 250 surface, the X-axis is a perpendicular direction to the Y-axis, and the Z-axis is a direction perpendicular to the surface of the reticle 220 or the object 250.

The projection optical system 240 may use an optical system solely including a plurality of lens elements, a catadioptric optical system including a plurality of lens elements and at least one concave mirror, an optical system including a plurality of lens elements and at least one diffractive optical element such as a kinoform, and a full mirror type optical system, and so on. Any necessary correction of the chromatic aberrations may use a plurality of lens units made from glass materials having different dispersion values (Abbe values) or can arrange a diffractive optical element such that it disperses in a direction opposite to that of the lens unit.

The photoresist is applied to the object 250. A photoresist application step includes a pretreatment, an adhesion accelerator application treatment, a photoresist application treatment, and a pre-bake treatment. The pretreatment includes cleaning, drying, etc. The adhesion accelerator application treatment is a surface reforming process so as to enhance the adhesion, between the photoresist and a base (i.e., a process to increase the hydrophobicity by applying a surface active agent), through a coat or vaporous process using an organic film such as HMDS (Hexamethyl-disilazane). The pre-bake treatment is a baking (or burning) step, softer than that after development, which removes the solvent.

The wafer stage 260 supports the object 250. The wafer stage 260 may use any structure known in the art, and a detailed description of its structure and operation will be omitted. The wafer stage 260 may use, for example, a linear motor to move the object 250 in the XY directions. The reticle 220 and object 250 are, for example, scanned synchronously, and the positions of the wafer stage 260 and reticle stage 230 are monitored, for example, by a laser interferometer so that both are driven at a constant speed ratio. The wafer stage 260 is installed on a stage stool supported on the floor and the like, for example, via a damper. The reticle stage and the projection optical system 240 are installed on a barrel stool (not shown) which is supported, for example, via a damper to a base frame on the floor.

A controller (or processor) 300 controls a driver 350, which will be described later, based on a measurement result by a measurement part 330, which will be described later.

The measurement part 330 serves to measure positions of the reticle stage 230 and the wafer stage 260, and send the positions to the controller 300.

The driver 350 serves to drive the reticle stage 230 and the wafer stage 260 under control by the controller 300.

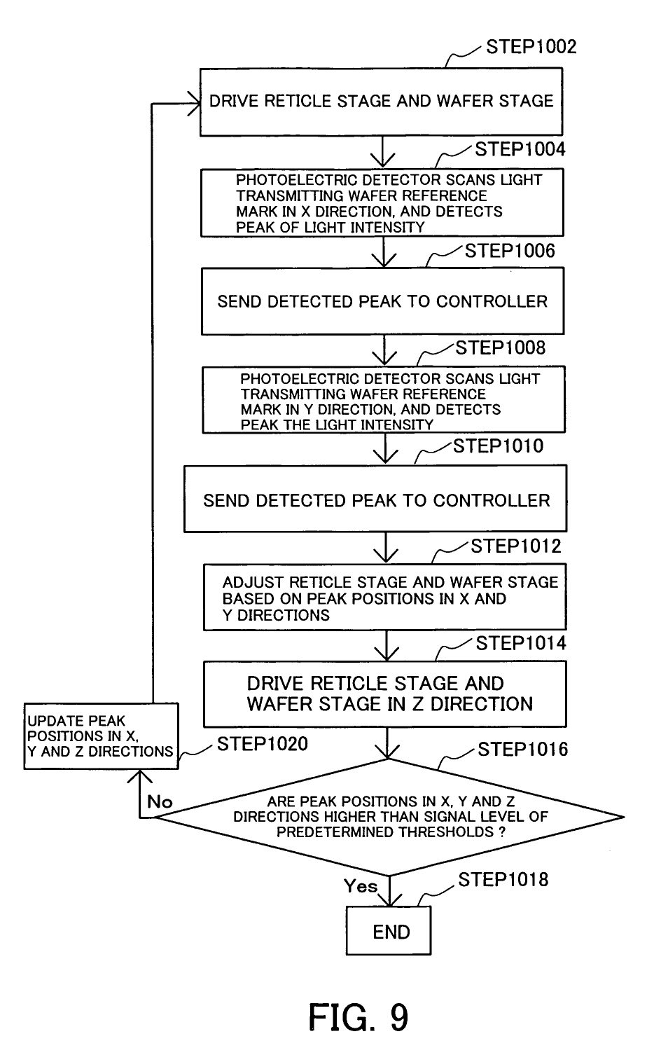

Referring now to FIG. 9, a description will be given of a position detecting method and an alignment method. Here, FIG. 9 shows a flowchart of the position detecting method and alignment method using the alignment means.

First, the reticle stage 230 and the wafer stage 260 are driven (step 1002). Here, the controller 300 reads location information from the measurement part 330, and instructs the driver 350 to drive the reticle stage 230 and the wafer stage 260 in the X and Y directions. Then, the measurement part 330 measures heights of the reticle stage 230 and the wafer stage 260 to drive the reticle stage 230 and the wafer stage 260 in the Z direction. The driver 350 drives the reticle stage 230 and the wafer stage 260 so that the focus accords with the imaging surface of the projection optical system 240.

Next, the photoelectric detector 160 scans in the X direction the light that has transmitted the wafer reference mark 130, and detects a peak of the light intensity (step 1004). The detected peak is sent to the controller 300 (step 1006). The scan may proceed with the left or right direction as long as it is along the X direction. The controller 300 obtains a peak position or location information from the photoelectric detector 160 and stores a scan position of the wafer stage 260 for scanning in the X direction. The controller 300 sequentially stores the peak position generated by the scanning.

Next, the photoelectric detector 160 scans in the Y direction the light that has transmitted the wafer reference mark 130, and detects a peak of the light intensity (step 1008). The detected peak is sent to the controller 300 (step 1010). Similar to steps 1004 and 1006, the scan may proceed with the left or right direction as long as it is along the Y direction. The controller 300 obtains a peak position from the photoelectric detector 160, and stores a scan position of the wafer stage 260 for scanning in the Y direction. The controller 300 sequentially stores the peak position generated by the scanning. The alignment means 100A to 100C of the above embodiments provide quick positional detections through simultaneous scanning in the X and Y directions. The precise and easy alignments improve the throughput and productivity.

The reticle stage 230 and the wafer stage 260 are adjusted based on the peak positions in the X and Y directions (step 1012). Here, the controller 300 refers to the stored peak positions, and obtains the maximum peak position in each of the X and Y directions. Since the starting positions of the reticle stage 230 and the wafer stage 260 are known, the maximum peak position can be easily obtained by calculating a distance from the starting position to the maximum peak position. Once the maximum peak position is obtained, the reticle stage 230 and the wafer stage 260 are driven to the peak position.

The reticle stage 230 and the wafer stage 260 are driven in the Z direction (step 1014). For the alignment in the Z direction, a measurement part (not shown) measures a focal point, detects the only peak at the focal point, and stores the Z coordinate and peak position of the peak in the controller 300.

It is determined whether the peak positions in the X, Y and Z directions are higher than signal levels of predetermined thresholds (step 1016). The alignment ends when the peak positions in the X, Y and Z directions are higher than the signal levels of the predetermined thresholds (step 1018). When the peak positions in the X, Y and Z directions are lower than the signal levels of the predetermined thresholds, the peak positions in the X, Y and Z directions are updated as initial positions and the procedure returns to step 1002 (step 1020). This method cannot obtain a sufficient signal level unless the other axes are almost properly aligned. Thus, when the positional offset is large, the procedure needs to be repeated in this way.

While this embodiment is suitable for a reflection reticle for the EUV exposes apparatus, the present invention is also applicable to an exposure apparatus that uses the i-line, KrF excimer laser, ArF excimer laser and F₂ laser for the light source. This alignment method facilitates the peak determination, and the alignment means 100 is less likely to provide an alignment based on an erroneous peak. The exposure apparatus 200 that has the alignment means 100 can maintain the resolution due to the highly accurate alignment. A sudden peak of the light intensity accelerates the positional detection without thorough scanning. This precise and easy alignment improves the throughput and productivity.

In exposure, the light emitted from the light source unit 212, e.g., Koehler-illuminated the reticle 220 via the illumination optical system 214. The light that passes the reticle 220 and reflects the reticle pattern is imaged onto the object 250 by the projection optical system 240. The illumination optical system 214 and the projection optical system 240 used by the exposure apparatus 200 has lens etc. and can transmit ultraviolet light, far ultraviolet light and vacuum ultraviolet light with high transmittance. Thus, the exposure apparatus 200 can provide devices, such as a semiconductor device, a LCD device, an image-pickup device, such as a CCD, and a thin film magnetic head, with a high throughput and economical efficiency.

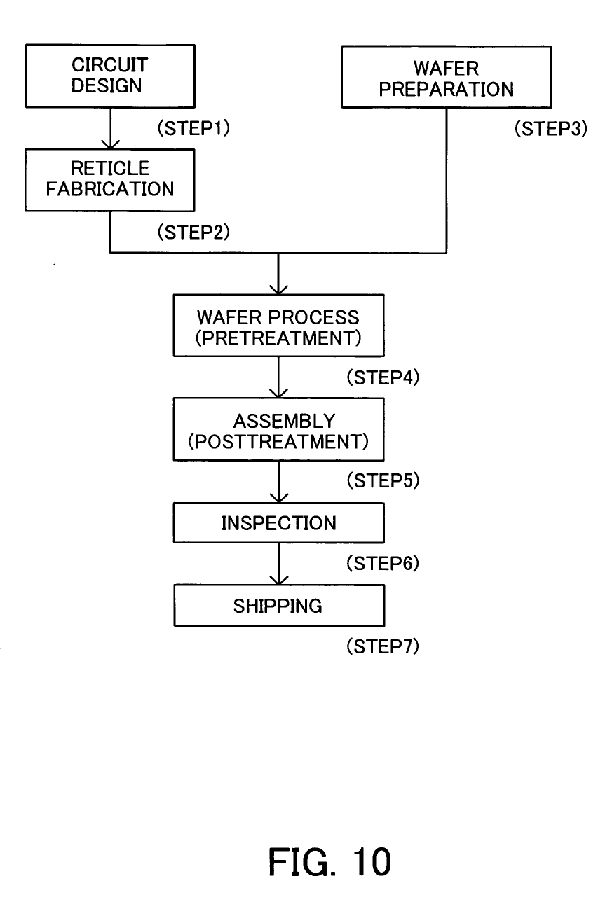

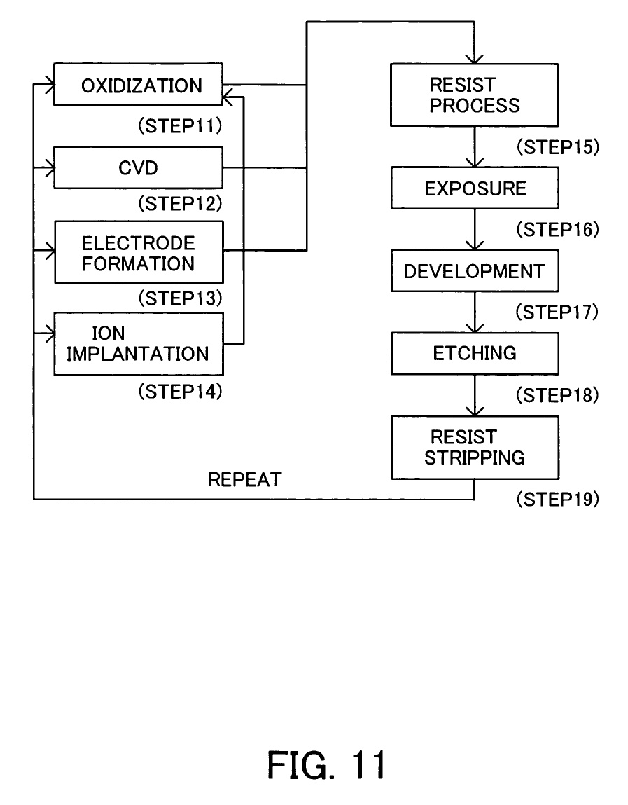

Referring now to FIGS. 10 and 11, a description will now be given of a device manufacturing method that uses the above exposure apparatus 200.

FIG. 10 is a flowchart for explaining the way of manufacturing devices (i.e., semiconductor chips such as IC and LSI, LCDs, CCDs, etc.). A description will now be given of the fabrication of a semiconductor chip as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms the actual circuitry on the wafer through photolithography of the present invention using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 11 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor arrangement and the like. Step 14 (ion implantation) implants ions into the wafer. Step 15 (resist process) applies a photosensitive material onto the wafer. Step 16 (exposure) uses the exposure apparatus 200 to expose a circuit pattern on the mask onto the wafer. Step 17 (development) develops the exposed wafer. Step 18 (etching) etches parts other than a developed resist image. Step 19 (resist stripping) removes unused resist after etching. These steps are repeated to form multilayer circuit patterns on the wafer. The device manufacturing method of the instant embodiment can fabricate higher quality devices than the conventional ones.

Thus, the above embodiments can provide an alignment means for achieving highly accurate and easy alignments, and an exposure apparatus having the alignment means.

This application claims a foreign priority benefit based on Japanese Patent Applications No. 2004-165878, filed on Jun. 3, 2004, which is hereby incorporated by reference herein in its entirety as if fully set forth herein.

1. A measuring apparatus for measuring relative positions between a first mark on a movable reticle stage to hold a reticle, and a second mark on a movable object stage to hold an object to be exposed, said apparatus comprising:
a detector for detecting light that has passed the first and second marks; and
a processor for calculating the relative positions based on an output of said detector,
wherein each of the first and second marks includes plural patterns to direct the light, at least ones of widths and intervals of the plural patterns being non-uniform.

2. A measuring apparatus according to claim 1, wherein the plural patterns are formed in accordance with a pseudorandom noise code.

3. A measuring apparatus according to claim 1, wherein at least one of the first and second marks includes plural kinds of the plural patterns.

4. A measuring apparatus according to claim 3, wherein the plural patterns include plural rectangular patterns, and each of the first and second marks includes two kinds of the rectangular pattern whose longitudinal directions are substantially orthogonal to each other.

5. A measuring apparatus according to claim 3, wherein the plural kinds of patterns include a first kind of the plural patterns, and a second kind of the plural patterns that has substantially the same shape as the first kind and has a phase different from that of the first kind.

6. A measuring apparatus according to claim 3, wherein the plural kinds of patterns include a first kind of the plural patterns, and a second kind of the plural patterns that has a height different from that of the first kind.

7. A measuring apparatus according to claim 1, wherein the first mark is provided on said movable reticle stage, and the second mark is provided on said movable object stage.

8. A measuring apparatus according to claim 1, wherein said detector detects the light that has passed the first and second marks and a projection optical system for projecting a pattern of the reticle onto the object.

9. An exposure apparatus for exposing an object to a pattern of a reticle, said apparatus comprising:
a movable reticle stage to hold the reticle;
a movable object stage to hold the object;
a measuring apparatus as defined in claim 1; and
a controller to control positions of said movable reticle stage and said movable object stage based on a relative position measured by said measuring apparatus.

10. A method of manufacturing a device, said method comprising steps of:
exposing an object to a pattern of a reticle using an exposure apparatus as defined in claim 9;
developing the exposed object; and
processing the developed object to manufacture the device.
